(19) United States
(12) Patent Application Publication
(10) Pub. No.: US 2025/0161909 A1
(43) Pub. Date: May 22, 2025

(54) POLYMER COMPOSITES FOR HARVESTING MOISTURE AND METHODS OF FABRICATION THEREOF

(71) Applicant: National University of Singapore, Singapore (SG)

(72) Inventors: Ramadan Abdelhamid Yousef Mohamed BORAYEK, Singapore (SG); Jun DING, Singapore (SG)

(21) Appl. No.: 18/836,138

(22) PCT Filed: Feb. 7, 2023
(86) PCT No.: PCT/SG2023/050065

§ 371 Date: Aug. 6, 2024

(30) Foreign Application Priority Data
Feb. 9, 2022 (SG) 10202201258R

(51) Int. Cl. B01J 20/26; B01D 53/02; B01D 53/26; B01D 53/28; B01J 20/28; B01J 20/34; E03B 3/28

(52) U.S. Cl. CPC B01J 20/267; B01D 53/02; B01D 53/261; B01D 53/28; B01J 20/28042; B01J 20/3425; B01J 20/3483; E03B 3/28; B01D 2257/80; B01D 2258/06; B01D 2259/40088

(57) ABSTRACT

The present disclosure concerns polymer composites for harvesting moisture and their uses thereof. The polymer composite comprises a hydrophilic polymer network and a hygroscopic salt intercalated within the polymer network. The weight ratio of the polymer network to the salt is about 0.1:1 to about 15:1. The present disclosure also concerns methods of fabricating the polymer composites.

### TECHNICAL FIELD

The present invention relates, in general terms, to polymer composites for harvesting moisture and their uses thereof. The present invention also relates to methods of fabricating the polymer composites.

### BACKGROUND

Our atmosphere has billions of gallons of water vapours. The existence of such water vapours in the atmosphere comes from the hydrologic cycle of the water (evaporation of the water to the atmosphere under the heat from sunlight then condensation of water droplets in the form of rains). Much efforts have been done to harvest the water from the surrounding atmosphere. All of the prior efforts lie between either the harvesting under very high humidity range 99% or harvesting under low humidity range.

The first route (harvest under high humidity range, 99%) is achieved through establishing vapour nets through large areas under high humidity. However, it always requires surveying the areas with high humidity during the early hours in the morning or night-time to start the harvesting of the water from the atmosphere. This approach is hindered by the geographic locations and the humidity levels which make it a difficult solution for continuity of the water supply.

The second approach (harvest under low humidity) uses hygroscopic materials with high polarity to chemically harvest the water molecules from the air then use heat energy to evaporate and condense the collected water. Various efforts have been done on this approach to overcome some of the existing challenges. These challenges arises due to the energy needed to evaporate then condense the harvested water according to the nature of the chemical bonding between the harvested water and the polymer network. Some efforts have been done to lower the energy needed for the evaporation process by adjusting the water state in the polymeric chain. These adjustments are relying on the chemical bond formation between the polymeric composite and the harvested water. In general, hydrogen bonding is the main chemical bond in that case. However, the state of such hydrogen bond can depend on the energy needed to break it and makes one molecule of water free to evaporate. This energy in general is lower than that when compared to one water molecule is evaporated by boiling. However, most of the materials used through literature are in the form of gels and cannot be self-standing for the use in the practical applications.

It would be desirable to overcome or ameliorate at least one of the above-described problems.

### SUMMARY

The present invention concerns polymer composites for harvesting the moisture from the air under different relative humidity ratios, and methods of fabrication thereof. The polymer composites can also store and release water from the humid air.

The present invention provides a polymer composite, comprising:
a) a hydrophilic polymer network; and
b) a hygroscopic salt intercalated within the polymer network;
   wherein a weight ratio of the polymer network to the salt is about 0.1:1 to about 15:1.

In some embodiments, the hydrophilic polymer network is a crosslinked polymer network.

In some embodiments, the hydrophilic polymer network is a polyacrylate network.

In some embodiments, the hydrophilic polymer network comprises ethylene glycol moieties.

In some embodiments, the hydrophilic polymer network comprises di(ethylene glycol).

In some embodiments, the hydrophilic polymer network comprises hydroxyl, alkyl, alkenyl, acyl, cyano, acrylate, or a combination thereof.

In some embodiments, the hydrophilic polymer network comprises hydroxypropyl and/or hydroxyethyl.

In some embodiments, the hydrophilic polymer network comprises ethylene glycol moieties and hydroxy moieties at a mole ratio of about 10:1000 to about 50:1000.

In some embodiments, the hygroscopic salt is an inorganic salt.

In some embodiments, the hygroscopic salt comprises a cation selected from Li, Na, K, Mg, Ca, Zn, Ni, Cu, Co, Al, or a combination thereof.

In some embodiments, the hygroscopic salt comprises an anion selected from fluoride, chloride, bromide, hydroxide, nitride, or a combination thereof.

In some embodiments, the hygroscopic salt is selected from lithium chloride, calcium chloride, zinc oxide, sodium chloride, and cobalt chloride.

In some embodiments, the weight ratio of the polymer network to the salt is about 0.4:1 to about 9:1.

In some embodiments, the polymer composite is 3D printable.

In some embodiments, the polymer composite further comprises a light absorber.

In some embodiments, the light absorber is selected from 5-bis(5-tert-butyl-benzoxazol-2-yl)thiophene.

In some embodiments, the polymer composite is characterised by a water absorption of about 0.5 g water per 1 g polymer composite to about 20 g water per 1 g polymer composite.

In some embodiments, the polymer composite is characterised by a water absorption of about 1 g water per 1 g polymer composite at a relative humidity of about 35%.

In some embodiments, the polymer composite is characterised by a water absorption of about 7 g water per 1 g polymer composite at a relative humidity of about 90%.

In some embodiments, the polymer composite is characterised by a water desorption at a temperature of at least about 50° C.

In some embodiments, when the polymer composite is saturated, the polymer composite is characterised by a complete water desorption when subjected to a temperature of about 60° C. for at least 40 min.

In some embodiments, the polymer composite is characterised by a stability of at least 100 cycles of water uptake and release.

In some embodiments, the polymer composite is characterised by a stability at a temperature of less than 250° C.

The present invention also provides water harvester, comprising:
a) absorbing means;
b) storage means; and
c) transfer means connecting the absorbing means to the storage means;
   wherein the absorbing means and storage means are formed from the polymer composite as disclosed herein.

In some embodiments, the absorbing means comprises a planar surface.

In some embodiments, the absorbing means comprises pores.

In some embodiments, the transfer means comprises columns substantially perpendicular to the absorbing means.

In some embodiments, the storage means comprises a 3D lattice.

In some embodiments, the 3D lattice is selected from a honeycomb, circular lattice, hexagonal lattice, tetrahedral lattice, octagonal lattice, kelvin lattice, rhombicuboctehedron lattice, or cubic lattice.

In some embodiments, the water harvester is 3D printed.

The present invention also provides a method of harvesting water vapour from air, comprising:
a) contacting a polymer composite as disclosed herein with air in order for water vapour to be absorbed by the polymer composite and stored as trapped water; and
b) exposing the polymer composite to heat in order to elute the trapped water.

In some embodiments, the trapped water is eluted via evaporation and/or condensation.

In some embodiments, the trapped water is eluted at a temperature of about 50° C. to about 100° C.

In some embodiments, the method further comprises a step of collecting the trapped water.

### BRIEF DESCRIPTION OF THE DRAWINGS

Embodiments of the present invention will now be described, by way of non-limiting example, with reference to the drawings in which:

FIG. 1 shows a scheme of the working principle and process for the polymer composite.

FIG. 2 shows a) comparison between commercially available materials for absorbing moisture/best materials in literature and a polymer composite, and b) swelled and dry state of a polymer composite.

FIG. 3 shows a) TGA results for fully cured, dry polymer composite sample and fully swelled polymer composite sample, and b) DSC results for polymer composite (hydrogel) and water.

FIG. 4 shows a) cyclic water absorption and desorption for a polymer composite, b) photos showing 3D printed lattice after swelling and before, c) water uptake as function of time for the polymer composite under 75% RH, and d) water desorption as function of time for a polymer composite sample under TGA.

FIG. 5 shows a) water uptake rate with time for a polymer composite sample under different RH ratios, c) water desorption rate for a polymer composite sample.

FIG. 6 shows photo of 3D printed water harvester for waterless planting and scanning electron micrographs.

FIG. 7 shows a) photos of 3D printed water harvester with plant for waterless planting, and b) humidity measurements for soil with time for different plants.

### DETAILED DESCRIPTION

Without wanting to be bound by theory, the mechanism of action relies on the bonding between highly hygroscopic materials and the highly absorbing polymer network. The hygroscopic materials work as humidity harvesters, while the polymer network works as a storage material for the harvested water. The presently disclosed polymer composites can absorb up to 7 times its own weight of water, in contrast to gel materials which can absorb only in the range of 3-4 times its own weight. The polymer composites can release the harvested water under low temperatures like 50-60° C. Various applications can be explored like waterless planting, cooling of electronic components based on phase change materials effect, drying and controlling relative humidity in open spaces and building management systems. It can also serve as a source of water for delivering fresh water to the areas with water scarcity.

Compared to existing technologies, the polymer composites have improved maximum absorption amounts and capacity. For example, the polymer composite can have a high capacity for humidity absorption. This allows it to be used as a drying agent for several times before saturation of water absorption, compared to commercially available materials like Silica gel and others. The polymer composite can absorb, store and release water. This makes it flexible as a material for environmental applications such as waterless planting and humidity control. In particular, because the polymer composite can absorb water under low humidity conditions, it can be used in harsh conditions like desert where there is no access to fresh water. The polymer composite is also 3D printable, and accordingly, structural designs can be further incorporated to increase the capacity of water uptake (by control the absorption rate and the speed of the cyclic absorption and desorption).

The present invention can be used in drying of containers for import and export, cooling of electronic components based on phase change materials, delivery of fresh water, waterless plantation, and dehumidification for green house farms.

The present invention provides a polymer composite, comprising:
a) a hydrophilic polymer network; and
b) a hygroscopic salt intercalated within the polymer network;
   wherein a weight ratio of the polymer network to the salt is about 0.1:1 to about 15:1.

The polymer network is a medium that can accommodate the salts and additionally water.

“Hydrophilic,” as used herein, refers to molecules which have a greater affinity for, and thus solubility in, water as compared to organic solvents. The hydrophilicity of a compound can be quantified by measuring its partition coefficient between water (or a buffered aqueous solution) and a water-immiscible organic solvent, such as octanol, ethyl acetate, methylene chloride, or methyl tert-butyl ether. If after equilibration a greater concentration of the compound is present in the water than in the organic solvent, then the compound may be considered to be hydrophilic.

“Hydrophobic,” as used herein, refers to molecules which have a greater affinity for, and thus solubility in, organic solvents as compared to water. The hydrophobicity of a compound can be quantified by measuring its partition coefficient between water (or a buffered aqueous solution) and a water-immiscible organic solvent, such as octanol, ethyl acetate, methylene chloride, or methyl tert-butyl ether. If after equilibration a greater concentration of the compound is present in the organic solvent than in the water, then the compound may be considered to be hydrophobic.

In some embodiments, the hydrophilic polymer network is a crosslinked polymer network. Crosslinking is the process of forming covalent bonds or relatively short sequences of chemical bonds to join two polymer chains together.

In some embodiments, the degree of polymerisation is about 500 to about 10,000. The degree of polymerisation is the frequency of repeating units present in a polymer. In other embodiments, the degree of polymerisation is about 1,000 to about 10,000, about 2,000 to about 10,000, about 2,000 to about 9,000, about 2,000 to about 8,000, about 2,000 to about 7,000, about 2,000 to about 6,000, about 2,000 to about 5,000, or about 2,000 to about 4,000.

In some embodiments, the crosslinking density is about 0.01 to about 0.9. The cross-link density is the density of chains or segments that connect two infinite parts of the polymer network. In other embodiments, the crosslinking density is about 0.01 to about 0.8, about 0.01 to about 0.7, about 0.01 to about 0.6, about 0.01 to about 0.5, about 0.01 to about 0.4, about 0.01 to about 0.3, about 0.01 to about 0.2, about 0.01 to about 0.1, about 0.01 to about 0.09, about 0.01 to about 0.08, about 0.01 to about 0.07, about 0.01 to about 0.06, about 0.01 to about 0.05, about 0.01 to about 0.04, about 0.01 to about 0.03, or about 0.01 to about 0.02. In other embodiments, the crosslinking density is about 0.014.

In some embodiments, the hydrophilic polymer network is a polyacrylate network.

In some embodiments, the hydrophilic polymer network comprises ethylene glycol moieties. In some embodiments, the hydrophilic polymer network comprises di (ethylene glycol), tri (ethylene glycol), poly (ethylene glycol) or a combination thereof.

The hydrophilic polymer may comprise hydrophilic moieties. The hydrophilic polymer may also comprise hydrophilic moieties in order to temper the characteristics of the hydrophilic polymer. In some embodiments, the hydrophilic polymer network comprises hydroxyl, alkyl, alkenyl, acyl, cyano, acrylate, or a combination thereof. In some embodiments, the hydrophilic polymer network comprises hydroxy moieties. “Oxo/hydroxy” refers to groups ═O, HO—. In some embodiments, the hydrophilic polymer network comprises hydroxypropyl and/or hydroxyethyl. In other embodiments, the hydrophilic polymer network comprises cellulose.

In some embodiments, the hydrophilic polymer network comprises ethylene glycol moieties and hydroxy moieties at a mole ratio of about 10:1000 to about 50:1000. In other embodiments, the mole ratio is about 15:1000 to about 50:1000, about 20:1000 to about 50:1000, about 25:1000 to about 50:1000, about 25:1000 to about 45:1000, about 25:1000 to about 40:1000, about 25:1000 to about 35:1000, or about 25:1000 to about 30:1000.

In some embodiments, the hydrophilic polymer is characterised by a ethylene glycol monomeric units weight ratio relative to a hydroxyl monomeric units of about 10% to about 40%. The monomeric unit refers to a group of atoms which is derived from a monomer, and which constitutes a unit of a polymer. In other embodiments, the weight ratio is about 10% to about 30%, or about 10% to about 20%. In other embodiments, the weight ratio is about 20%.

In some embodiments, the hydrophilic polymer comprises alkyl moieties. The alkyl moieties may be methyl, ethyl, propyl, or iso-propyl.

Hygroscopy is the phenomenon of attracting and holding water molecules via either absorption or adsorption from the surrounding environment, which is usually at normal or room temperature. Also included within this scope are deliquescent materials which are sufficiently hygroscopic that they absorb so much water that they become liquid and form an aqueous solution.

In some embodiments, the hygroscopic salt comprises a cation selected from Li, Na, K, Mg, Ca, Zn, Ni, Cu, Co, Al, or a combination thereof.

In some embodiments, the hygroscopic salt comprises an anion selected from fluoride, chloride, bromide, hydroxide, nitride, or a combination thereof.

In some embodiments, the hygroscopic salt is an inorganic salt. In some embodiments, the hygroscopic salt is selected from LiCl. In some embodiments, the hygroscopic salt is selected from calcium chloride, zinc oxide, sodium chloride, and cobalt chloride.

In some embodiments, the weight ratio of the polymer network to the salt is about 0.4:1 to about 9:1. In other embodiments, the weight ratio is about 0.5:1 to about 9:1, about 1:1 to about 9:1, about 1.5:1 to about 9:1, about 2:1 to about 9:1, about 2.5:1 to about 9:1, about 3:1 to about 9:1, about 3.5:1 to about 9:1, about 4:1 to about 9:1, about 4.5:1 to about 9:1, about 5:1 to about 9:1, about 5.5:1 to about 9:1, about 6:1 to about 9:1, about 6.5:1 to about 9:1, about 7:1 to about 9:1, about 7.5:1 to about 9:1, or about 8:1 to about 9:1.

The polymer composite may be prepared as a viscous liquid or gel. In some embodiments, the polymer composite is 3D printable. In this regard, the polymer composite may be printed and subsequently photo-cured in order to get fully cured structure without any other residues of un-cured liquid resins. For example, the photoinitiator may be diphenyl(2,4,6-trimethylbenzoyl)phosphine oxide (TPO). The amount of photoinitiator may be varied in order to control the rate of printing.

In some embodiments, the weight ratio of the photoinitiator relative to the hydrophilic polymer is about 2% to about 10%. In other embodiments, the weight ratio is about 2% to about 9%, about 2% to about 8%, about 2% to about 7%, about 2% to about 6%, about 2% to about 5%. In other embodiments, the weight ratio is about 5%.

UV light absorbers, optical brighteners, optical brightening agents (OBAs), fluorescent brightening agents (FBAs), or fluorescent whitening agents (FWAs), are chemical compounds that absorb light in the ultraviolet and violet region (usually 340-370 nm) of the electromagnetic spectrum, and re-emit light in the blue region (typically 420-470 nm) by fluorescence. These additives are often used to enhance the appearance of colour of materials, causing a “whitening” effect; they make intrinsically yellow/orange materials look less so, by compensating the deficit in blue and purple light reflected by the material, with the blue and purple optical emission of the fluorophore.

In some embodiments, the polymer composite further comprises a light absorber. In some embodiments, the optical brightener is selected from 5-bis(5-tert-butyl-benzoxazol-2-yl)thiophene, 4,4′-diamino-2,2′-stilbenedisulfonic acid.

In some embodiments, the weight ratio of the light absorber relative to the hydrophilic polymer is about 2% to about 10%. In other embodiments, the weight ratio is about 2% to about 9%, about 2% to about 8%, about 2% to about 7%, about 2% to about 6%, about 2% to about 5%. In other embodiments, the weight ratio is about 5%.

The polymer composite is able to absorb water. For example, the polymer composite may absorb water molecules from humid air. In some embodiments, the polymer composite is characterised by a water absorption of about 0.5 g water per 1 g polymer composite to about 20 g water per 1 g polymer composite. In other embodiments, the water absorption is about 1 g water per 1 g polymer composite (1 g/g) to about 20 g water per 1 g polymer composite (20 g/g), 2 g/g to about 20 g/g, 3 g/g to about 20 g/g, 4 g/g to about 20 g/g, 4 g/g to about 18 g/g, 4 g/g to about 16 g/g, 4 g/g to about 14 g/g, 4 g/g to about 12 g/g, 4 g/g to about 10 g/g, 5 g/g to about 10 g/g, 6 g/g to about 10 g/g, 7 g/g to about 10 g/g, 7 g/g to about 9 g/g, or 7 g/g to about 8 g/g.

In some embodiments, the polymer composite is characterised by a water absorption of about 1 g water per 1 g polymer composite at a relative humidity of about 35%.

In some embodiments, the polymer composite is characterised by a water absorption of about 7 g water per 1 g polymer composite at a relative humidity of about 90%.

When the polymer composite contains water, the polymer composite is able to release the contained water. For example, the absorbed water may be evaporated from the polymer composite, or may be released as a liquid based on a humidity difference. In some embodiments, the polymer composite is characterised by a water desorption at a temperature of at least about 50° C. In other embodiments, the water desorption occurs at at least about 40° C., about 45° C., about 55° C., about 60° C., or about 70° C.

In some embodiments, when the polymer composite is saturated, the polymer composite is characterised by a complete water desorption when subjected to a temperature of about 60° C. for at least 40 min.

In some embodiments, the polymer composite is characterised by a stability of at least 100 cycles of water uptake and release.

In some embodiments, the polymer composite is characterised by a stability at a temperature of less than 250° C. This stability is a stability against degradation.

The present invention also provides water harvester, comprising:
a) absorbing means;
b) storage means; and
c) transfer means connecting the absorbing means to the storage means;
   wherein the absorbing means and storage means are formed from the polymer composite as disclosed herein.

In some embodiments, the polymer composite in the absorbing means is a polyacrylate network comprising di(ethylene glycol) and hydroxypropyl, and an inorganic salt. The inorganic salt may be hydroscopic.

In some embodiments, the polymer composite in the transfer means is a polyacrylate network comprising di(ethylene glycol) and hydroxyethyl, and cellulose. The cellulose can be hydroxyethyl cellulose. The transfer means may be void of hydroscopic salts, or may comprise a relatively smaller amount compared to absorbing means.

In some embodiments, the polymer composite in the storage means is a polyacrylate network comprising di(ethylene glycol) and hydroxyethyl, and an inorganic salt. The inorganic salt may be hydroscopic.

The transfer means connects the absorbing means to the storage means such that water vapour absorbed at the absorbing means can be fluidly communicated to the storage means. As the transfer means is merely for transferring absorbed water to the storage, its volume may be reduced in order to improve the transfer rate and/or minimise water being trapped within the transfer means.

In some embodiments, the absorbing means comprises a planar surface. In some embodiments, the absorbing means comprises pores. The pore size can be from about 200 μm to about 500 μm.

In some embodiments, the transfer means comprises columns substantially perpendicular to the absorbing means. In some embodiments, the transfer means comprises pores. The pore size can be from about 200 μm to about 500 μm.

In some embodiments, the storage means comprises a 3D lattice. In this way, the storage means is formed as a structure with a plurality of holes. In some embodiments, the 3D lattice is selected from a honeycomb, circular lattice, hexagonal lattice, tetrahedral lattice, octagonal lattice, kelvin lattice, rhombicuboctehedron lattice, or cubic lattice.

In some embodiments, the storage means comprises pores. The pore size can be from about 200 μm to about 500 μm.

In some embodiments, the water harvester is 3D printed.

The present invention also provides a method of harvesting water vapour from air, comprising:
a) contacting a polymer composite as disclosed herein with air in order for water vapour to be absorbed by the polymer composite and stored as trapped water; and
b) exposing the polymer composite to heat in order to elute the trapped water.

In some embodiments, the trapped water is eluted via evaporation and/or condensation.

In some embodiments, the trapped water is eluted at a temperature of about 50° C. to about 100° C.

In some embodiments, the method further comprises a step of collecting the trapped water.

### EXAMPLES

### Sample Preparation

Materials used: Hydroxypropyl acrylate (HPA), mixture of isomers, containing 900-1100 ppm 4-methoxyphenol as inhibitor; Hydroxyethyl acrylate (HEA), Diethylene Glycol diacrylate (DEGDA), diphenyl(2,4,6-trimethylbenzoyl)phosphine oxide (TPO), 2,5-bis(5-tert-butyl-benzoxazol-2-yl)thiophene, Hydroxyethyl cellulose (HEC) and LiCl powder, were purchased from Sigma Aldrich and have been used without further purifications.

### Example 1

88 gm of HPA (Hydroxypropyl acrylate) monomer+2 gm of diethylene glycol diacrylate (DEGDA)+10 gm of LiCl+0.5 gm of the diphenyl(2,4,6-trimethylbenzoyl)phosphine oxide (TPO)+0.05 gm 2,5-bis(5-tert-butyl-benzoxazol-2-yl)thiophene.

### Example 2

88 gm of HEA (Hydroxyethyl acrylate) monomer+2 gm of diethylene glycol diacrylate (DEGDA)+10 gm of LiCl+0.5 gm of the diphenyl(2,4,6-trimethylbenzoyl)phosphine oxide (TPO)+0.05 gm 2,5-bis(5-tert-butyl-benzoxazol-2-yl)thiophene.

### Example 3

10mL of HEA (Hydroxyethyl acrylate) monomer+2 mL of diethylene glycol diacrylate (DEGDA)+90 ml of LiCl solution (8M)+0.5 gm of the diphenyl(2,4,6-trimethylbenzoyl)phosphine oxide (TPO)+0.05 gm 2,5-bis(5-tert-butyl-benzoxazol-2-yl)thiophene.

### Example 4 (Polymer Composite for Transfer Means)

10 mL of HEA (Hydroxyethyl acrylate) monomer+2 mL of diethylene glycol diacrylate (DEGDA)+10 mL of HEC solution (2 gm dissolved in 50 ml water)+0.5 gm of the diphenyl(2,4,6-trimethylbenzoyl)phosphine oxide (TPO)+0.05 gm 2,5-bis(5-tert-butyl-benzoxazol-2-yl)thiophene.

### 3D Printing

The 3D printing of the harvester is based on UV printing methods. The wave length of the printer and the initiators is matched for the printing process. In the above examples, TPO acts as the photoinitiator for the digital light processing (DLP) UV printer.

### Results

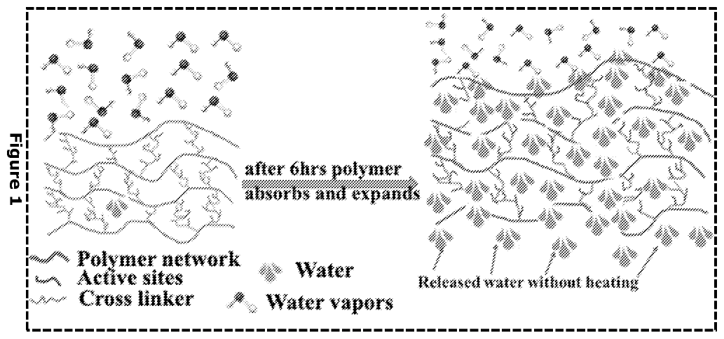

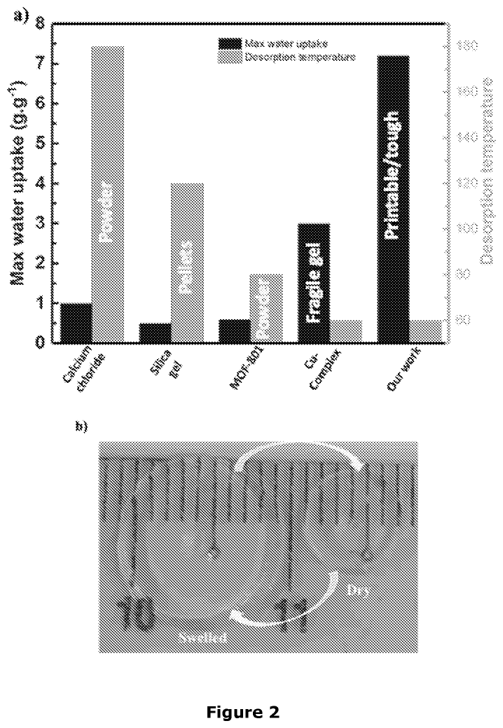

As shown in FIG. 1, the polymer composite is able to harvest the water molecules from the humid air (humidity from 10% to 99%). After saturation absorption, the composite is able to release some of the absorbed water. Under sunlight, the rest of the absorbed water can be evaporated and condensed on a transparent surface. The condensed water can be collected in water tanks and flow down under its own weight due to gravity. This closed loop process allows the delivery of water without consuming energy inputs. The polymer composite is able to absorb up to 7 times its own weight, as shown in FIG. 2. Comparing to other materials in market, the presently disclosed polymer composite is able to release the absorbed water under a low temperature ranging from 50 to 60° C. Accordingly, the polymer composite is able to harvest and deliver water with very low energy input which may come directly from the sun light during the day.

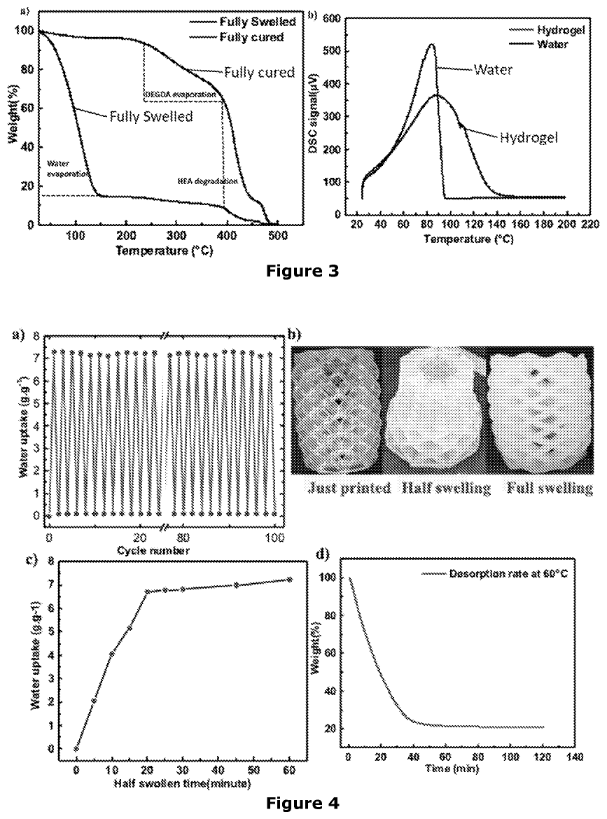

This performance of the polymer composite is believed to be due to the nature of the components present in the polymer composite. The composites rely on the synergistic (or at least additive) combination of highly hygroscopic salts with highly hydrophilic polymer network. Through the bonding between the polymer network and the hygroscopic salt, the composite is able to harvest the water molecules from the air and the polymer network is able to store the water inside up to the maximum capacity of the polymer network. The polymer can uptake water up to 20 times its own weight if immersed in the water. When mixing with the hygroscopic salt, the overall water uptake have been to be in about 7 times the initial weight of the polymer composite. The polymer composite is found to be stable under more than 100 cyclic water uptake and release process with very little fluctuations in the cyclic performance. The TGA results in FIG. 3a shows the thermal degradation of the polymer composite under the increase in the temperature. For the dry sample, the composite was stable up to 250° C. Once the temperature starts to raise to 250° C., the DEGDA starts degrade, then full degradation starts after 400° C. However, for the wet sample, the composite starts to lose all the absorbed water starting from 50° C. till 100° C. for the full evaporation. Also, the same degradation behaviour take place again like the dry sample once the total amounts of water evaporated. The DSC results in FIG. 3b shows the difference of the required energy to evaporate the pure water and the absorbed water in the polymer composite (hydrogel). The absorbed water in the hydrogel needs less energy than the pure water to be evaporated.

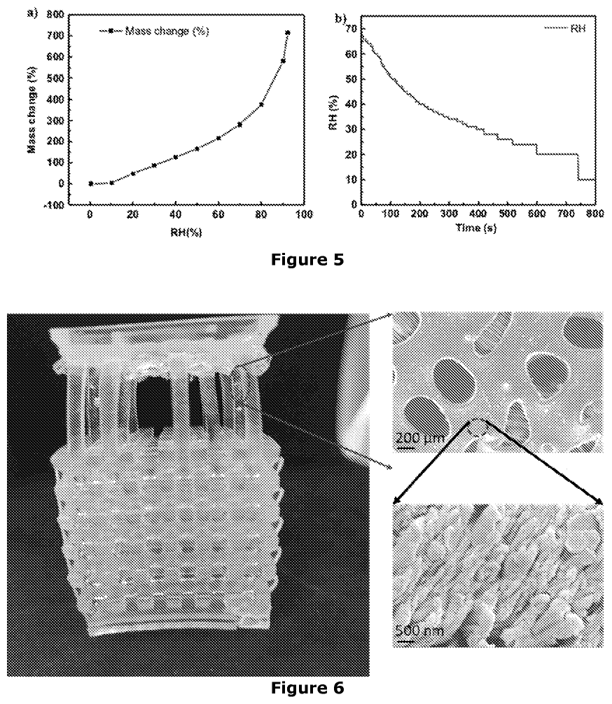

The cyclic absorption and desorption of the composite is shown in FIG. 4a. From FIG. 4a, the composite showed highly stable desorption and desorption cycles of over than 100 cycles with very small fluctuations in the performance. 3D printed structures have been explored also as shown in FIG. 4b. The rate of the water uptake is shown in FIG. 4c. The used sample size reaches the maximum absorption within almost 60 minutes. The desorption of the same sample has been studied under the TGA at 60° C. and it can release all the water at 60° C. within around 40 minutes. The polymer composite was studied under different relative humidity. The composite shows unique performance under different relative humidity as shown in FIG. 5a. FIG. 5b is showing the relative humidity change with time for the condition of FIG. 5a.

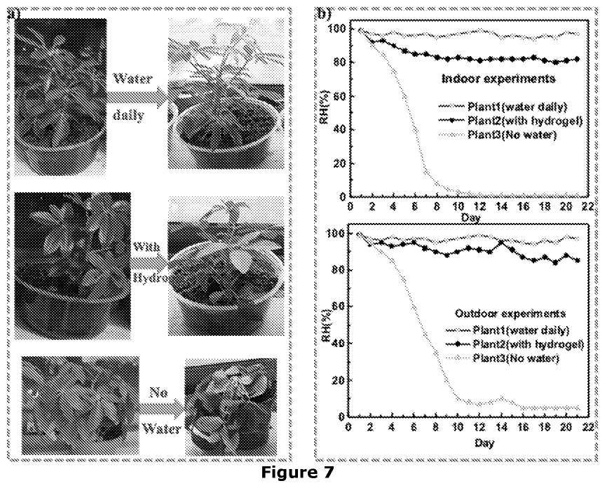

The 3D printability of the polymer composite was explored and a structure for planting without water was designed (water harvester). The structure shown in FIG. 6a consists of three parts. The top part is to harvest the moisture and the middle part is to transfer the water, while the bottom part is to store and release the water. Every part has different material formulations to do the required function. In FIG. 7, the 3D printed structure was tested and compared relative to positive and negative controls. A single plant genre was used and tested under three different conditions. As a positive control, the first plant was irrigate every day. The second plant was planted with the 3D printed structure and irrigated once at the beginning. As a negative control, the third plant was not irrigated. FIG. 7b shows the humidity measurement in the soil for 22 days. The results show that the 3D printed structure helps the plant to sustain the necessary relative humidity for the plant to grow up.

As another example, Example 1 can be used as the polymer composite for the absorbing means as the affinity for water vapour is high. Example 4 can be used as the polymer composite for the transfer means as the lack of a hydroscopic salt prevents (or at least reduces) its affinity for retaining water and hence it can function to transfer water to the storage means and also the presence of cellulose functional groups allow the transfer of water by fibre exist on cellulose groups. The storage means may be Example 1, 2 or 3. In use, the storage means may be in an enclosed environment and not exposed to ambient humidity. When the water in the storage means exceeds it maximum capacity, the excess water may be collected in a container. Alternatively, the enclosed environment may comprise heating means to desorb water from the storage means.

As a comparator, a water harvester built using Example 4 (without hydroscopic salt) was not effective in collecting and storing water from humid air.

### CONCLUSION

A polymer composite for harvesting humidity from the air was developed. The formulated material was able to harvest water up to 7 times its own weight. The composite also was found to be able to harvest the water under different relative humidity ratios ranging from 10% till 99%. The absorbed water can be released under low temperatures less than 60° C. A water harvester was formed to explore waterless planting. The structure shown herein has a unique performance for absorbing, transferring, and storing the water. The stored water was able to be released to the soil because of the difference in the relative humidity between the soil and the storage materials. 3D printing has been helped to print the designed structure for waterless planting. The composite can lead to many other environmental and energy savings applications.

It will be appreciated that many further modifications and permutations of various aspects of the described embodiments are possible. Accordingly, the described aspects are intended to embrace all such alterations, modifications, and variations that fall within the spirit and scope of the appended claims.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

Throughout this specification and the claims which follow, unless the context requires otherwise, the phrase “consisting essentially of”, and variations such as “consists essentially of” will be understood to indicate that the recited element(s) is/are essential i.e. necessary elements of the invention. The phrase allows for the presence of other non-recited elements which do not materially affect the characteristics of the invention but excludes additional unspecified elements which would affect the basic and novel characteristics of the method defined.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A polymer composite, comprising:
a) a hydrophilic polymer network; and
b) a hygroscopic salt intercalated within the polymer network;
wherein a weight ratio of the polymer network to the salt is about 0.1:1 to about 15:1.

2. The polymer composite according to claim 1, wherein the hydrophilic polymer network is a crosslinked polymer network.

3. The polymer composite according to claim 1, wherein the hydrophilic polymer network is a polyacrylate network.

4. The polymer composite according to claim 1, wherein the hydrophilic polymer network comprises ethylene glycol moieties.

5. (canceled)

6. The polymer composite according to claim 1, wherein the hydrophilic polymer network comprises hydroxyl, alkyl, alkenyl, acyl, cyano, acrylate, or a combination thereof.

7. (canceled)

8. The polymer composite according to claim 1, wherein the hydrophilic polymer network comprises ethylene glycol moieties and hydroxy moieties at a mole ratio of about 10:1000 to about 50:1000.

9. The polymer composite according to claim 1, wherein the hygroscopic salt is an inorganic salt.

10. The polymer composite according to claim 1,
wherein the hygroscopic salt comprises a cation selected from Li, Na, K, Mg, Ca, Zn, Ni, Cu, Co, Al, or a combination thereof; and
wherein the hygroscopic salt comprises an anion selected from fluoride, chloride, bromide, hydroxide, nitride, or a combination thereof.

11.-13. (canceled)

14. The polymer composite according to claim 1, wherein the polymer composite is 3D printable.

15. The polymer composite according to claim 1, wherein the polymer composite further comprises a light absorber.

16. The polymer composite according to claim 15, wherein the light absorber is selected from 5-bis(5-tert-butyl-benzoxazol-2-yl)thiophene.

17. The polymer composite according to claim 1, wherein the polymer composite is characterised by at least one of the following:
a) a water absorption of about 0.5 g water per 1 g polymer composite;
b) a water absorption of about 1 g water per 1 g polymer composite at a relative humidity of about 35%;
c) a water absorption of about 7 g water per 1 g polymer composite at a relative humidity of about 90%;
d) a water desorption at a temperature of at least about 50° C.;
e) when the polymer composite is saturated, the polymer composite is characterised by a complete water desorption when subjected to a temperature of about 60° C. for at least 40 min;
f) a stability of at least 100 cycles of water uptake and release; and
g) a stability at a temperature of less than 250° C. to about 20 g water per 1 g polymer composite.

18.-23. (canceled)

24. A water harvester, comprising:
a) absorbing means;
b) storage means; and
c) transfer means connecting the absorbing means to the storage means;
wherein the absorbing means and storage means are formed from the polymer composite according to claim 1.

25. The water harvester according to claim 24, wherein the absorbing means comprises a planar surface and/or pores.

26. (canceled)

27. The water harvester according to claim 24, wherein the transfer means comprises columns substantially perpendicular to the absorbing means.

28. The water harvester according to claim 24, wherein the storage means comprises a 3D lattice.

29.-30. (canceled)

31. A method of harvesting water vapour from air, comprising:
a) contacting a polymer composite according to claim 1 with air in order for water vapour to be absorbed by the polymer composite and stored as trapped water; and
b) exposing the polymer composite to heat in order to elute the trapped water.

32. The method according to claim 31, wherein the trapped water is eluted via evaporation and/or condensation.

33. The method according to claim 31, wherein the trapped water is eluted at a temperature of about 50° C. to about 100° C.

34. The method according to claim 31, wherein the method further comprises a step of collecting the trapped water.
